(19) United States
(12) Patent Application Publication
(10) Pub. No.: US 2009/0198830 A1
(43) Pub. Date: Aug. 6, 2009

(54) METHOD OF ADJUSTING NETWORK DATA SENDING SPEED ACCORDING TO DATA PROCESSING SPEED AT CLIENT

(75) Inventors: Yue ZHANG, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/026,787

(22) Filed: Feb. 6, 2008

(51) Int. Cl. G06F 15/16; G06F 7/44

(52) U.S. Cl. 709/233; 708/651

(57) ABSTRACT

A method of adjusting a network data sending speed according to a data processing speed at a client is described. Through calculating and feeding back a data processing speed of a client computer to a server; and then, controlling and adjusting a data sending speed at the server in real time according to the data processing speed, the server adjusts the data sending speed thereof in real time according to the requirement on speed control, and sends data to the client computer at an adjusted data sending speed. This method controls and adjusts the data sending speed at the server through a feedback mechanism of the data processing speed of the client computer, thereby avoiding problems in the conventional art, such as low network data transmission efficiency and data loss, caused by mismatching between the data processing speed at the client and the data sending speed at the server.

### BACKGROUND OF THE INVENTION

1. Field of Invention

The present invention relates to a method of controlling network data transmission speed, and more particularly to a method of adjusting a network data sending speed according to a data processing speed at a client.

2. Related Art

Currently, User Datagram Protocol (UDP) adopted in a conventional Internet data transmission technique is a connectionless network data transmission protocol, and does not have traffic control and data retransmission mechanism compared with Transmission Control Protocol (TCP). Therefore, when the data processing efficiency at the client is low, meanwhile the data sending speed at the server is high, a large number of data packets may be dropped out or retransmitted, thus resulting in problems such as low network data transmission efficiency and data loss.

Thus, it is urgent to provide a method of controlling a network data transmission speed through the UDP, so as to ensure reliable data transmission, and efficient use of network bandwidth, thereby preventing deteriorating the network transmission performance caused by data loss and data retransmission.

### SUMMARY OF THE INVENTION

To solve the above-mentioned problems and defects in the conventional art, the present invention is directed to a method of adjusting a network data sending speed according to a data processing speed at a client. This method controls and adjusts the data sending speed at the server through a feedback mechanism of the data processing speed at the client, thereby avoiding problems and defects in the conventional art caused by mismatching between the data processing speed at the client and the data sending speed at the server.

A method of adjusting a network data sending speed according to a data processing speed at a client is provided, which includes the following steps.

First, a network connection channel for transmitting data and a network connection channel for feeding back data are established between a client computer and a server. Next, the server sends data to the client computer through the network connection channel for transmitting data at a preset initial data sending speed within a preset period of initialization time. After that, the client computer receives the data from the server, then processes the data, and records the data processing time. Then, the client computer calculates the data processing speed thereof in real time according to the amount of the data processed and the data processing time, and feeds back the information about the data processing speed to the server through the network connection channel for feeding back data. Next, the server receives the information about the data processing speed fed back from the client computer, and controls and adjusts the data sending speed thereof in real time according to the data processing speed after the initialization time. Thereafter, the server adjusts the data sending speed thereof in real time according to the requirement on speed control, and sends data to the client computer at an adjusted data sending speed through the network connection channel for transmitting data.

In view of the above, the method of adjusting a network data sending speed according to a data processing speed at a client provided by the present invention has the following advantages.

According to the method of the present invention, data is transmitted reliably through a special network connection channel for transmitting data, for example, UDP, and the information about the data processing speed of the client computer is reliably fed back to the server in real time through a special network connection channel for feeding back data, for example, TCP, such that the server may adjust the data sending speed thereof in real time according to the data processing speed of the client computer. As such, this method prevents data packet dropout, and avoids problems of data loss and data retransmission in the conventional art caused by mismatching between the data processing speed at the client and the data sending speed at the server, thereby greatly enhancing the network bandwidth utilization and the network data transmission performance.

### BRIEF DESCRIPTION OF THE DRAWINGS

The present invention will become more fully understood from the detailed description given herein below for illustration only, and thus are not limitative of the present invention, and wherein:

FIG. 1 is a block view of a system in which a method of adjusting a network data sending speed according to a data processing speed at a client provided by the present invention runs; and

FIG. 2 is a flow chart showing all the steps in a method of adjusting a network data sending speed according to a data processing speed at a client provided by the present invention.

### DETAILED DESCRIPTION OF THE INVENTION

Preferred embodiments of the present invention will be illustrated in detail below with the accompanying drawings.

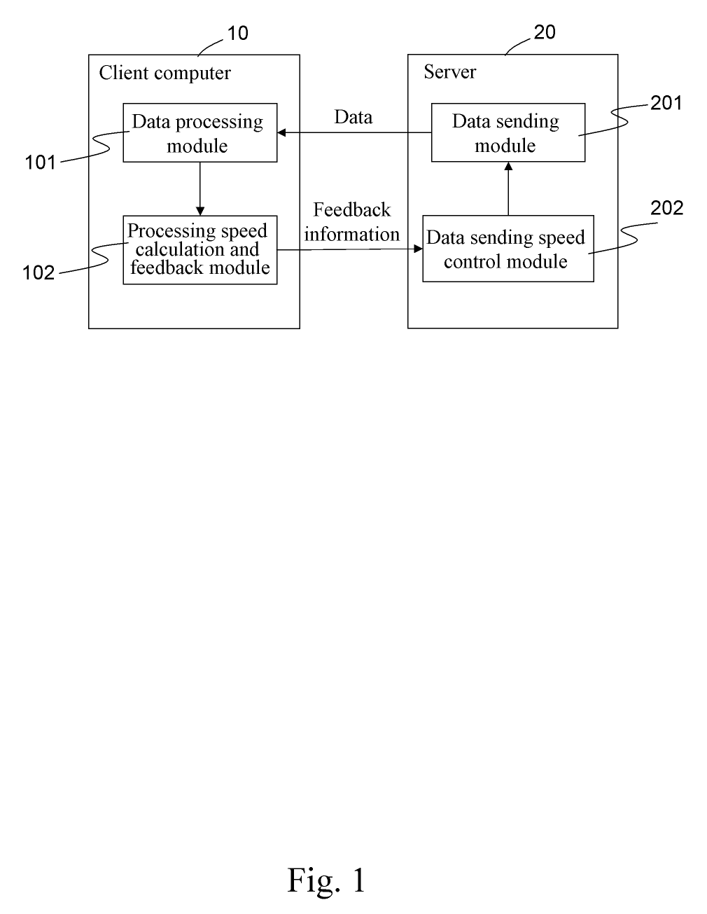

Referring to FIG. 1, a block view of a system in which a method of adjusting a network data sending speed according to a data processing speed at a client provided by the present invention runs is shown. In FIG. 1, the system includes a client computer 10 and a server 20. Further, the client computer 10 includes a data processing module 101 and a processing speed calculation and feedback module 102. The server 20 includes a data sending module 201 and a data sending speed control module 202.

The data processing module 101 receives data from the server 20, performs data processing including decompression and disk writing, and records a data processing time. The processing speed calculation and feedback module 102 calculates the data processing speed of the data processing module 101 in the client computer 10 in real time according to the amount of the data processed and the data processing time, and feeds back the information about the data processing speed to the data sending speed control module 202 of the server 20 through a TCP. The data sending speed control module 202 receives the information about the data processing speed fed back from the client computer 10, and controls and adjusts the data sending speed of the data sending module 201 in real time according to the data processing speed. The data sending module 201 sends data to the data processing module 101 of the client computer 10 through a UDP, and adjusts the data sending speed thereof in real time according to the requirement on speed control from the data sending speed control module 202.

Moreover, at the beginning, the server 20 is unable to predict the data processing speed of the client computer 10, so during the first period of operating time, the server 20 sends data to the client computer 10 at a low initial data sending speed (preset by the system as 1 Mbit/s). After this period of time, since the data processing speed of the client computer 10 is stabilized, the feedback control mechanism between the client computer 10 and the server 20 is employed to control and adjust the data sending speed at the server 20. Thus, the above first period of operating time is defined as an initialization time Ti, which is a preset time value. That is, though in the initialization time Ti, the processing speed calculation and feedback module 102 in the client computer 10 still feeds back the information about the data processing speed to the data sending speed control module 202 of the server 20, only after the system operating time is larger than the initialization time Ti, the data sending speed control module 202 will control and adjust the data sending speed of the data sending module 201 in the server 20 in real time according to the data processing speed fed back by the client computer 10.

In addition, the processing speed calculation and feedback module 102 calculates the data processing speed of the processing module 101 by adopting the following formula:

data processing speed Sp=amount of the data processed Lp÷data processing time Tp, and the data processing time Tp=time point when data writing ends Tp2−time point when data reception begins Tp1.

Besides, the data sending speed control module 202 controls and adjusts the data sending speed of the data sending module 201 in real time according to the data processing speed by adopting the following steps and formulae:

(1) calculating a total time required for sending data Ttotal according to the data processing speed Sp, in which the total time required for sending data Ttotal=amount of the data sent Ls÷data processing speed Sp;

(2) calculating a real time spent in sending data Treal, in which the real time spent in sending data Treal=time point when data sending ends Ts2−time point when data sending begins Ts1;

(3) calculating a system congestion time Tk, in which the system congestion time Tk=total time required for sending data Ttotal−real time spent in sending data Treal; and

(4) adopting an Application Program Interface (API) provided by an operating system, in which a Sleep(time) function makes the data sending process temporarily halted/congested in the data sending module 201 for a period of time, the halt/congestion time is a value of the parameter “time”, which is equal to the system congestion time Tk, such that the average data sending speed of the data sending module 201 is lowered to fulfill the real-time control and adjustment of the data sending speed, so as to avoid problems of data packet dropout and retransmission caused by an over-high data sending speed at the server.

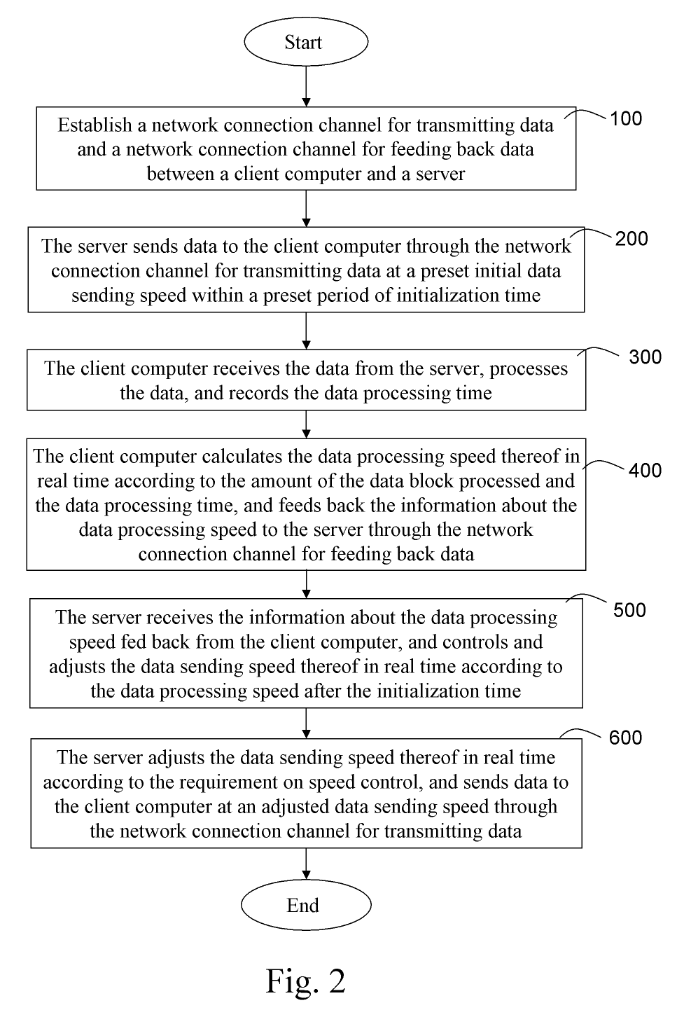

Next, referring to FIG. 2, a flow chart listing all the steps in a method of adjusting a network data sending speed according to a data processing speed at a client provided by the present invention is shown. In FIG. 2, the method includes the following steps.

First, a network connection channel for transmitting data and a network connection channel for feeding back data are established between a client computer and a server (Step 100).

Next, the server sends data to the client computer through the network connection channel for transmitting data at a preset initial data sending speed within a preset period of initialization time (Step 200), in which the network connection channel for transmitting data transmits data through a UDP.

After that, the client computer receives the data from the server, processes the data, and records a data processing time (Step 300), in which data processing includes decompression and disk writing.

Then, the client computer calculates the data processing speed thereof in real time according to the amount of the data block processed and the data processing time, and feeds back the information about the data processing speed to the server through the network connection channel for feeding back data (Step 400), in which the network connection channel for feeding back data transmits the fed-back information about the data processing speed through a TCP.

Next, the server receives the information about the data processing speed fed back from the client computer, and controls and adjusts the data sending speed thereof in real time according to the data processing speed after the initialization time (Step 500).

Thereafter, the server adjusts the data sending speed thereof in real time according to the requirement on speed control, and sends data to the client computer at an adjusted data sending speed through the network connection channel for transmitting data (Step 600).

In addition, in Step 400, the client computer calculates the data processing speed thereof in real time according to the amount of the data processed and the data processing time by adopting the following formula:

data processing speed=amount of the data processed÷data processing time, in which the data processing time=time point when data processing ends (i.e., the time point when data decompression and disk writing are finished)−time point when data reception begins.

Further, in Step 500, the controlling and adjusting the data sending speed at the server in real time according to the data processing speed are performed through the following steps and formulae:

(1) calculating a total time required for sending data according to the data processing speed, in which the total time required for sending data=amount of the data sent÷data processing speed;

(2) calculating a real time spent in sending data, in which the real time spent in sending data=time point when data sending ends−time point when data sending begins;

(3) calculating a system congestion time, in which the system congestion time=the total time required for sending data−the real time spent in sending data; and

(4) adopting an API provided by an operating system, in which a Sleep(time) function makes the data sending process temporarily halted/congested in the server for a period of time, the halt /congestion time is a value of the parameter “time”, which is equal to the system congestion time, such that the average data sending speed at the server is lowered to fulfill the real-time control and adjustment of the data sending speed, so as to avoid problems of data packet dropout and retransmission caused by an over-high data sending speed at the server.

Moreover, in the above method of adjusting a network data sending speed according to a data processing speed at a client provided by the present invention, at the beginning, the server is unable to predict the data processing speed of the client computer, so during the first period of operating time, the server sends data to the client computer at a low initial data sending speed (preset by the system as 1 Mbit/s). After this period of time, since the data processing speed of the client computer is stabilized, the feedback control mechanism between the client computer and the server is employed to control and adjust the data sending speed at the server. Thus, the above first period of operating time is defined as an initialization time, which is a preset time value. That is, though in the initialization time, the client computer still feeds back the information about the data processing speed to the server, only after the system operating time is larger than the initialization time, the server will control and adjust the data sending speed at the server in real time according to the data processing speed fed back by the client computer. The above method of adjusting a network data sending speed according to a data processing speed at a client provided by the present invention will be further illustrated below with an example.

In the current enterprise, relative working personnel have to allocate computers to those newcomers, and install a customized operating system in each new computer. Usually, the customized operating system is made into a mirror file, which is then copied and restored into the designated computer on demand, thus finishing installing an operating system to a new computer.

In order to fulfill the above task more efficiently, a software realizing the method provided by the present invention can be adopted. The software has two functions: first, the server reads the data of the mirror file and sends the data to the client computer; secondly, the client computer receives the data of the mirror file from the server, decompresses the data, and writes the decompressed data into a disk, thereby completing the copy and restoration operation of the mirror file.

In particular, the aforementioned process has the following steps.

Step 1: two network connection channels are established between a client computer and a server, in which the two channels are respectively a data transmission channel based on a UDP multicast protocol and an information feedback channel based on a TCP;

Step 2: within an initialization time Ti=5 s, the server sends data to the client computer at an initial speed of 1 Mbit/s. As the hard disk of the system has a currently high performance, the data processing speed thereof may reach 50 Mbit/s, so the client computer may not cause data packet dropout due to the performance bottleneck of the hard disk;

Step 3: the server controls and adjusts the data sending speed thereof in real time according to the data processing speed (50 Mbit/s) fed back from the client computer after the initialization time, and thus the data sending speed at the server rises to 50 Mbit/s. As the data sending speed at the server well matches the data processing speed of the client computer, data can be efficiently transmitted without causing problems of data packet dropout and data retransmission;

Step 4: as the data processing speed of the client computer drops to 40 Mbit/s due to some factors in the client computer (for example, the hardware getting overheated or the impact from other input/output operations), the data processing speed is fed back to the server in real time. Thereby, the data sending speed at the server is adjusted in real time to 40 Mbit/s;

Step 5: if the above factors that impact the data processing performance of the client computer are eliminated, the data processing speed of the client computer is restored to 50 Mbit/s. Then, the restored data processing speed is fed back to the server in real time, and the data sending speed at the server is adjusted in real time to 50 Mbit/s;

Step 6: during the subsequent data transmission process, the circumstances in Steps 3 to 5 may occur repeatedly, and the data sending speed at the server always changes in real time with the data processing speed of the client computer, thereby ensuring an efficient data transmission process.

The aforementioned data processing speed of the client computer for determining the data sending speed at the server is not set by the user, but is set based on the information about the data processing speed fed back from the client computer continuously and dynamically in real time, thereby avoiding problems of data packet dropout and retransmission caused by an over-high data sending speed at the server.

Further, for data blocks with a fixed data amount, the real time spent in sending data Treal at the server is actually constant. If it is assumed that the server sends a data block with a data amount of 32 KB, from the beginning to the end of the data sending, the real time spent in sending data Treal is 5 ms, as shown below:

| Data processing speed | 50 Mbit/s | 40 Mbit/s |
|---|---|---|
| Total time required for sending data | 100 ms | 120 ms |
| System congestion time | 95 ms | 115 ms |

When the data processing speed of the client computer is 50 Mbit/s, it only takes 5 ms for the server to send a data block with a data amount of 32 KB in practice. However, according to the method provided by the present invention, to meet the requirement on speed control, the data sending process must be halted/congested for 95 ms before starting to send the next data block, thereby making the data sending speed at the server match the data processing speed of the client computer as 50 Mbit/s. When the data processing speed of the client computer drops to 40 Mbit/s, it only takes 5 ms for the server to send a data block with a data amount of 32 KB in practice. However, according to the method provided by the present invention, to meet the requirement on speed control, the data sending process must be halted/congested for 115 ms before starting to send the next data block, thereby making the data sending speed at the server match the data processing speed of the client computer as 40 Mbit/s.

What is claimed is:

1. A method of adjusting a network data sending speed according to a data processing speed at a client, comprising:
establishing a network connection channel for transmitting data and a network connection channel for feeding back data between a client computer and a server;
the server sending data to the client computer through the network connection channel for transmitting data at a preset initial data sending speed within a preset period of initialization time;
the client computer receiving the data from the server, processing the data, and recording a data processing time;
the client computer calculating the data processing speed thereof in real time according to the amount of the data processed and the data processing time, and feeding back the information about the data processing speed to the server through the network connection channel for feeding back data;
the server receiving the information about the data processing speed fed back from the client computer, and controlling and adjusting the data sending speed thereof in real time according to the data processing speed after the initialization time; and
the server adjusting the data sending speed thereof in real time according to the requirement on speed control, and sending data to the client computer at an adjusted data sending speed through the network connection channel for transmitting data.

2. The method of adjusting a network data sending speed according to a data processing speed at a client as claimed in claim 1, wherein the data processing comprises decompression and disk writing.

3. The method of adjusting a network data sending speed according to a data processing speed at a client as claimed in claim 1, wherein the network connection channel for transmitting data transmits data through a User Datagram Protocol (UDP).

4. The method of adjusting a network data sending speed according to a data processing speed at a client as claimed in claim 1, wherein the network connection channel for feeding back data transmits the fed-back information about the data processing speed through a Transmission Control Protocol (TCP).

5. The method of adjusting a network data sending speed according to a data processing speed at a client as claimed in claim 1, wherein the client computer calculates the data processing speed thereof in real time according to the amount of the data processed and the data processing time by adopting the following formula:
data processing speed=amount of the data processed÷data processing time, wherein, the data processing time=time point when data processing ends−time point when data reception begins.

6. The method of adjusting a network data sending speed according to a data processing speed at a client as claimed in claim 1, wherein the controlling and adjusting the data sending speed at the server in real time according to the data processing speed comprises the following steps and formulae:
(1) calculating a total time required for sending data according to the data processing speed, wherein the total time required for sending data=amount of the data sent÷data processing speed;
(2) calculating a real time spent in sending data, wherein the real time spent in sending data=time point when data sending ends−time point when data sending begins;
(3) calculating a system congestion time, wherein the system congestion time=the total time required for sending data−the real time spent in sending data; and
(4) temporarily halting/congesting the data sending process in the server for a period of time, wherein the halt/congestion time is equal to the system congestion time.

7. The method of adjusting a network data sending speed according to a data processing speed at a client as claimed in claim 6, wherein the method adopts an Application Program Interface (API) provided by an operating system; a Sleep(time) function makes the data sending process temporarily halted/congested in the server for a period of time, in which the halt/congestion time is a value of the parameter “time”, which is equal to the system congestion time.
